(19) United States
(12) Patent Application Publication
(10) Pub. No.: US 2014/0160107 A1
(43) Pub. Date: Jun. 12, 2014

(54) CHARGE SHARING APPARATUS AND CHARGE SHARING METHOD

(71) Applicant: Raydium Semiconductor Corporation, Hsinchu (TW)

(72) Inventors: Yu-Lung Lo, New Taipei (TW); Yu-Chun Lin, Kinmen County (TW); Chih-Hsien Jen, Hsinchu City (TW)

(73) Assignee: Raydium Semiconductor Corporation, Hsinchu (TW)

(21) Appl. No.: 14/099,645

(22) Filed: Dec. 6, 2013

(30) Foreign Application Priority Data
Dec. 12, 2012 (TW) 101146900

(51) Int. Cl. G09G 3/36

(52) U.S. Cl. CPC G09G 3/3648
USPC 345/212; 345/92

(57) ABSTRACT

A charge sharing apparatus and a charge sharing method applied in a driving circuit of a liquid crystal display are disclosed. The driving circuit includes at least one data latch and at least one output switch. The charge sharing apparatus includes a generating module and an adjusting module. The generating module is coupled to the at least one data latch and used for generating at least one charge sharing level according to at least one data signal inputted to the at least one data latch. The adjusting module is coupled between the generating module and the at least one output switch and used for selectively adjusting level changing state of at least one output signal outputted by the at least one output switch according to the at least one charge sharing level.

### CROSS-REFERENCE TO RELATED APPLICATIONS

This application claims priority to Taiwan Application Serial Number 101146900, filed Dec. 12, 2012, which is incorporated by reference herein in its entirety.

### BACKGROUND OF THE INVENTION

1. Field of the Invention

The invention relates to a liquid crystal display; in particular, to a charge sharing apparatus and a charge sharing method applied in a driving circuit of a liquid crystal display.

2. Description of the Prior Art

In general, the multi-phase charge sharing technology can be used in the thin-film-transistor liquid crystal display (TFT-LCD) to prevent frame twinkling Conventionally, in the TFT-LCD using the multi-phase charge sharing technology, a switch unit is used to couple odd source lines and even source lines to an external capacitor unit in a period of multi-phase charge sharing time to share the charges in the source lines.

From above, the charge sharing method used in conventional TFT-LCD is to couple the odd source lines and the even source lines. Please refer to FIG. 1A and FIG. 1B. FIG. 1A illustrates a schematic diagram of output waveform of the conventional TFT-LCD without charge sharing; FIG. 1B illustrates a schematic diagram of output waveform of the conventional TFT-LCD performing charge sharing. As shown in FIG. 1B, when the TFT-LCD performs multi-phase charge sharing, in the ideal condition, the levels of the first output signal O1 in the odd source line and the second output signal O2 in the even source line will be balanced at a reference level V_{COM} in the period of multi-phase charge sharing time Δt.

Please refer to FIG. 1C and FIG. 1D. FIG. 1C illustrates a schematic diagram of another output waveform of the conventional TFT-LCD without charge sharing; FIG. 1D illustrates a schematic diagram of another output waveform of the conventional TFT-LCD performing charge sharing. FIG. 1E illustrates a schematic diagram of another output waveform of the conventional TFT-LCD without charge sharing.

However, in practical, since recombination of the positive charge and negative charge is not always balanced at the reference level V_{COM}, when the positive polarity and negative polarity of the data signal are exchanged, the source driver has to provide more charges; therefore, it will cause problems of high total power consumption and poor driving efficiency. In addition, the conventional TFT-LCD using the multi-phase charge sharing method fails to adjust the level changing state of the data signal with specific data type shown in FIG. 1E.

Therefore, the invention provides a charge sharing apparatus and a charge sharing method applied in a driving circuit of a liquid crystal display to solve the above-mentioned problems occurred in the prior arts.

### SUMMARY OF THE INVENTION

An embodiment of the invention is a charge sharing apparatus. In this embodiment, the charge sharing apparatus is applied in a driving circuit of a liquid crystal display. The driving circuit includes at least one data latch and at least one output switch. The charge sharing apparatus includes a generating module and an adjusting module. The generating module is coupled to the at least one data latch and used for generating at least one charge sharing level according to at least one data signal inputted to the at least one data latch. The adjusting module is coupled between the generating module and the at least one output switch and used for selectively adjusting a level changing state of at least one output signal outputted by the at least one output switch according to the at least one charge sharing level.

In an embodiment, the generating module includes a data determining unit. The data determining unit is used to determine data type of the at least one data signal inputted to the at least one data latch and generate the at least one charge sharing level accordingly.

In an embodiment, the at least one charge sharing level is between a maximum level and a minimum level of the at least one output signal, but different from a reference level of the driving circuit.

In an embodiment, the at least one charge sharing level is between a maximum level of the at least one output signal and a reference level of the driving circuit and/or between the reference level and a minimum level of the at least one output signal, the reference level is between the maximum level and the minimum level.

In an embodiment, when a level variation curve versus time of the output signal is increased or decreased to the charge sharing level, the level variation curve versus time of the output signal maintains at the charge sharing level.

In an embodiment, the at least one data latch includes a first data latch unit and a second data latch unit used to receive a first data signal and a second data signal of the at least one data signal respectively; the at least one output switch includes a first output switch and a second output switch used to output a first output signal and a second output signal of the at least one output signal respectively.

In an embodiment, the driving circuit further includes a first level shifter, a first digital-to-analog converter, a first amplifier, a second level shifter, a second digital-to-analog converter, and a second amplifier; the first data signal received by the first data latch unit is processed by the first level shifter, the first digital-to-analog converter, the first amplifier in order to become the first output signal and the first output signal is outputted by the first output switch; the second data signal received by the second data latch unit is processed by the second level shifter, the second digital-to-analog converter, the second amplifier in order to become the second output signal and the second output signal is outputted by the second output switch.

Another embodiment of the invention is a charge sharing method applied in a driving circuit of a liquid crystal display. The driving circuit includes at least one data latch and at least one output switch. The method includes steps of: (a) generating at least one charge sharing level according to at least one data signal inputted to the at least one data latch; and (b) selectively adjusting a level changing state of at least one output signal outputted by the at least one output switch according to the at least one charge sharing level.

Compared to the prior art, the charge sharing apparatus and charge sharing method of the invention provide at least one charge sharing level different from the reference level between the maximum level and minimum level of the data signal to adjust the level changing state of the output signal. Therefore, when the positive polarity and negative polarity of the data signal are exchanged, the source driver has not to provide more charges to effectively reduce total power consumption and enhance driving efficiency.

The advantage and spirit of the invention may be understood by the following detailed descriptions together with the appended drawings.

### BRIEF DESCRIPTION OF THE APPENDED DRAWINGS

FIG. 1A illustrates a schematic diagram of output waveform of the conventional TFT-LCD without charge sharing; FIG. 1B illustrates a schematic diagram of output waveform of the conventional TFT-LCD performing charge sharing.

FIG. 1C illustrates a schematic diagram of another output waveform of the conventional TFT-LCD without charge sharing; FIG. 1D illustrates a schematic diagram of another output waveform of the conventional TFT-LCD performing charge sharing.

FIG. 1E illustrates a schematic diagram of another output waveform of the conventional TFT-LCD without charge sharing.

FIG. 2 illustrates a functional block diagram of the charge sharing apparatus applied in a driving circuit of a liquid crystal display in an embodiment of the invention.

FIG. 3A illustrates a schematic diagram of output waveform of the charge sharing apparatus when the charge sharing apparatus performs charge sharing (compared with FIG. 1B).

FIG. 3B illustrates a schematic diagram of another output waveform of the charge sharing apparatus when the charge sharing apparatus performs charge sharing (compared with FIG. 1B).

FIG. 4A illustrates a schematic diagram of output waveform of the charge sharing apparatus when the charge sharing apparatus performs charge sharing (compared with FIG. 1D).

FIG. 4B illustrates a schematic diagram of another output waveform of the charge sharing apparatus when the charge sharing apparatus performs charge sharing (compared with FIG. 1D).

FIG. 5 illustrates a schematic diagram of another output waveform of the charge sharing apparatus when the charge sharing apparatus performs charge sharing (compared with FIG. 1E).

FIG. 6 illustrates a flow chart of the charge sharing method in another embodiment of the invention.

### DETAILED DESCRIPTION OF THE INVENTION

An embodiment of the invention is a charge sharing apparatus. In this embodiment, the charge sharing apparatus is applied in a driving circuit of a liquid crystal display, but not limited to this.

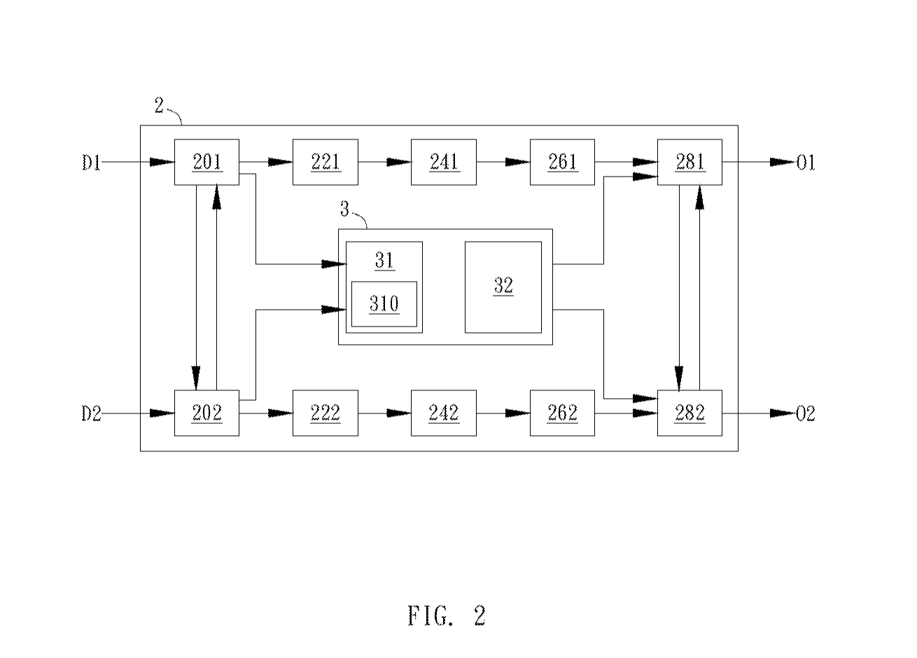

Please refer to FIG. 2. FIG. 2 illustrates a functional block diagram of the charge sharing apparatus applied in a source driving circuit of a liquid crystal display. As shown in FIG. 2, the source driving circuit 2 includes a first data latch 201, a second data latch 202, a first level shifter 221, a second level shifter 222, a first digital-to-analog converter 241, a second digital-to-analog converter 242, a first amplifier 261, a second amplifier 262, a first output switch 281, and a second output switch 282. The charge sharing apparatus 3 includes a generating module 31 and an adjusting module 32. The generating module 31 includes a data determining unit 310. The first data latch 201, the first level shifter 221, the first digital-to-analog converter 241, the first amplifier 261, and the first output switch 281 can be included in a first channel. The second data latch 202, the second level shifter 222, the second digital-to-analog converter 242, the second amplifier 262, and the second output switch 282 can be included in a second channel.

In this embodiment, the generating module 31 is coupled to the first data latch 201 and the second data latch 202; the adjusting module 32 is coupled to the generating module 31, the first output switch 281, and the second output switch 282; the first data latch 201 is coupled to the second data latch 202; the first level shifter 221 is coupled between the first data latch 201 and the first digital-to-analog converter 241; the first digital-to-analog converter 241 is coupled to the first amplifier 261; the first amplifier 261 is coupled to the first output switch 281; the first output switch 281 is coupled to the second output switch 282; the second level shifter 222 is coupled between the second data latch 202 and the second digital-to-analog converter 242; the second digital-to-analog converter 242 is coupled to the second amplifier 262; the second amplifier 262 is coupled to the second output switch 282.

In the source driving circuit 2, the first channel receives and processes the first data signal D1 on the odd source line and then outputs a first output signal O1; the second channel receives and processes the second data signal D2 on the even source line and then outputs a second output signal O2. That is to say, the first data signal D1 on the odd source line is inputted to the first data latch 201 and the second data signal D2 on the even source line is inputted to the second data latch 202. In fact, the first data signal D1 and the second data signal D2 can be a data signal with positive polarity and a data signal with negative polarity respectively, but not limited to this.

Then, the first data signal D1 is processed by the first level shifter 221, the first digital-to-analog converter 241, and the first amplifier 261 to become the first output signal O1, and then the first output switch 281 outputs the first output signal O1. Similarly, the second data signal D2 is processed by the second level shifter 222, the second digital-to-analog converter 242, and the second amplifier 262 to become the second output signal O2, and then the second output switch 282 outputs the second output signal O2.

In this embodiment, the function of the charge sharing apparatus 3 is to use a target level (the first data signal D1 and the second data signal D2) to determine whether the charge sharing is necessary. If yes, the charge sharing apparatus 3 will perform the charge sharing, so that (1) the charge sharing level is equal to the reference level V_{COM}; or (2) the charge sharing level is equal to any level CSL1 between the reference level V_{COM} and the maximum level V+ and any level CSL2 between the reference level V_{COM} and the minimum level V−; or (3) the charge sharing level is equal to the reference level V_{COM} at first, and then equal to any level CSL1 between the reference level V_{COM} and the maximum level V+ and any level CSL2 between the reference level V_{COM} and the minimum level V−.

In the charge sharing apparatus 3, the generating module 31 is used to generate at least one charge sharing level according to the first data signal D1 and the second data signal D2 inputted to the first data latch 201 and the second data latch 202. That is to say, the generating module 31 can only generate one charge sharing level or more charge sharing levels without any specific limitations depending on practical needs. It should be noted that at least one charge sharing level generated by the generating module 31 of the invention is between the maximum level V+ and the minimum level V− of the first output signal O1 and the second output signal O2, but different from the reference level V_{COM} of the source driving circuit 2.

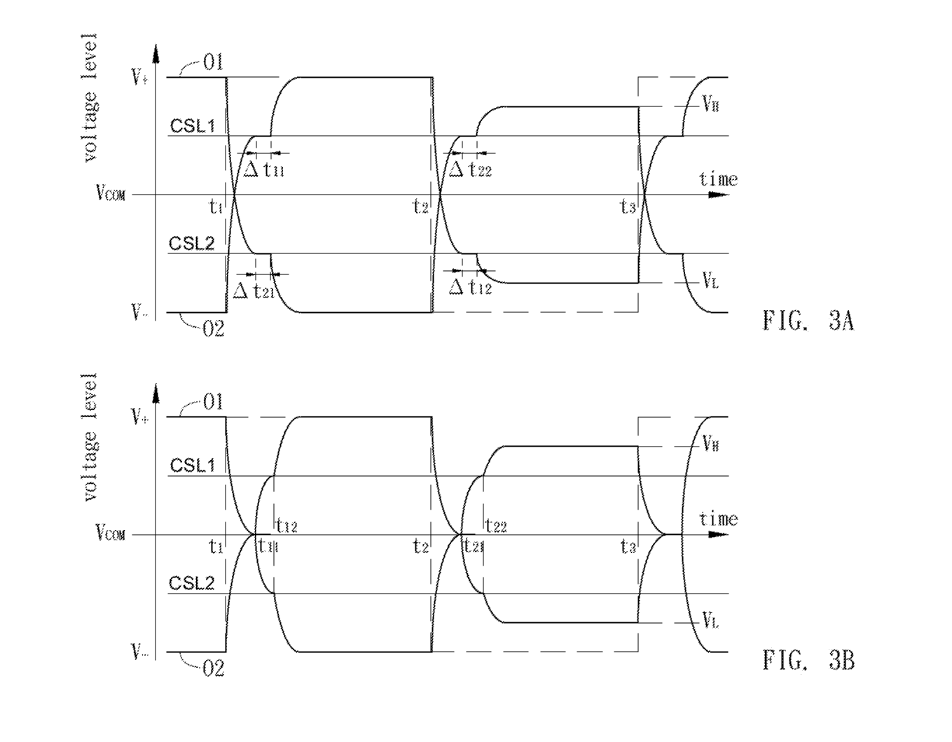

For example, as shown in FIG. 3A, the reference level V_{COM} of the source driving circuit 2 is between the maximum level V+ and the minimum level V−. It is assumed that the generating module 31 totally generates the first charge sharing level CSL1 and the second charge sharing level CSL2, wherein the first charge sharing level CSL1 is between the maximum level V+ of the output signal and the reference level V_{COM}, and the second charge sharing level CSL2 is between the minimum level V− of the output signal and the reference level V_{COM}.

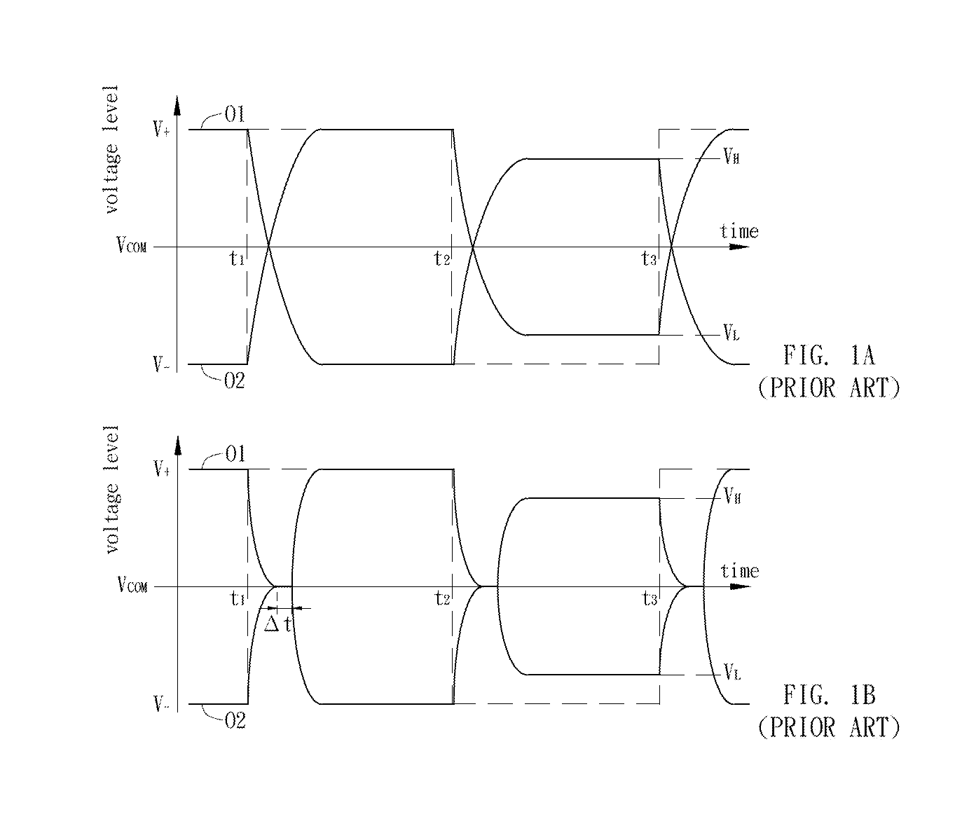

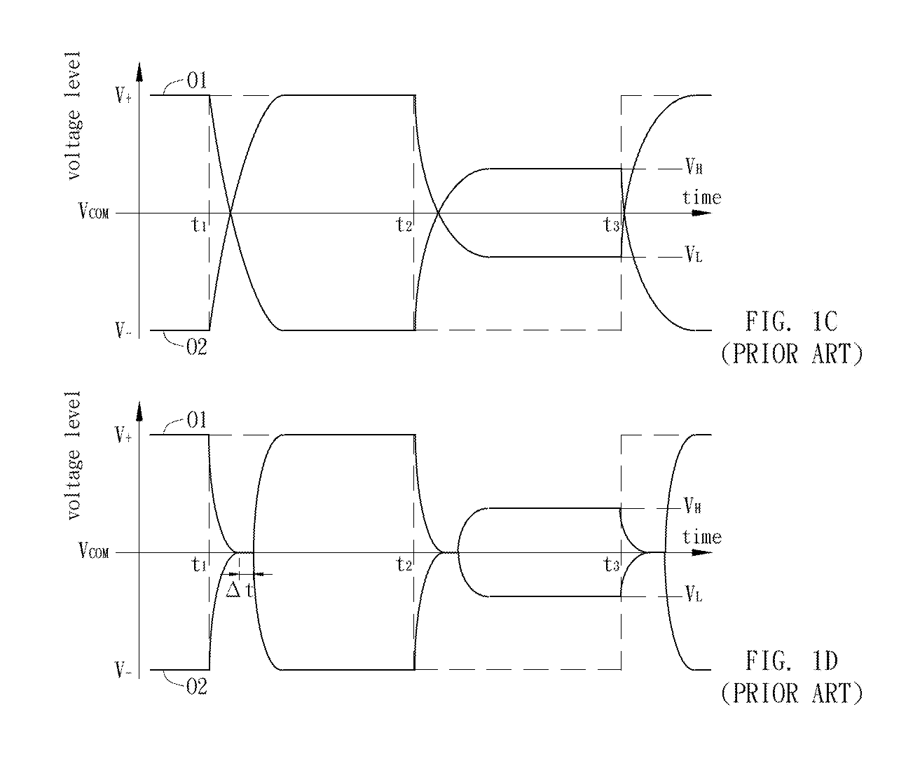

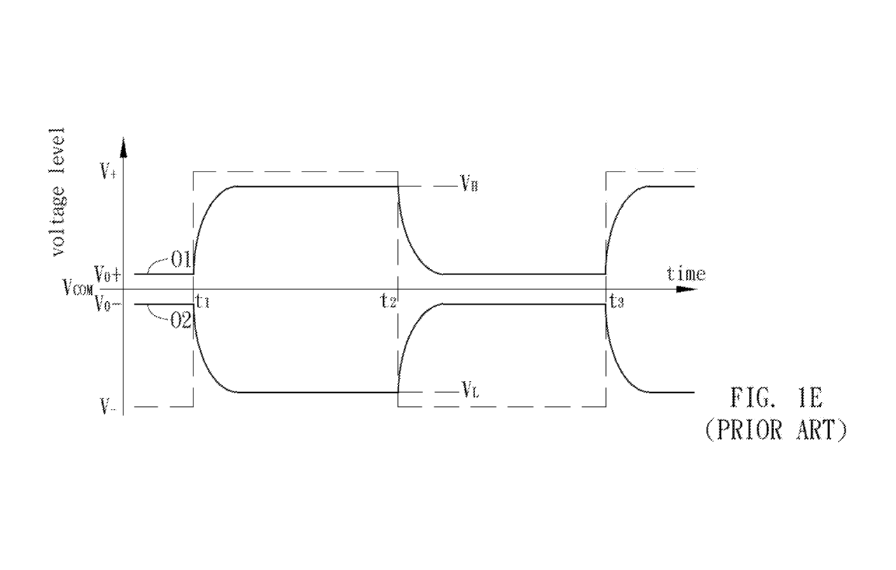

In practical applications, the generating module 31 can use the data determining unit 310 to determine the data type of the first data signal D1 and the second data signal D2 inputted to the first data latch 201 and the second data latch 202 respectively and then generate the at least one charge sharing level accordingly. For example, the data type of the first data signal D1 and the second data signal D2 can be any type of data signal shown in FIG. 1A˜FIG. 1E, but not limited to this.

In this embodiment, the adjusting module 32 is used to selectively adjust the level changing state of the first output signal O1 and the second output signal O2 outputted by the first output switch 281 and the second output switch 282 respectively according to the at least one charge sharing level generated by the generating module 31. A cycle of the first output signal O1 and the second output signal O2 starts from a first time t₁ to a third time t₃.

Next, various embodiments will be introduced. In the following embodiments, the first charge sharing level CSL1 is between the maximum level V+ of the output signal and the reference level V_{COM}, and the second charge sharing level CSL2 is between the minimum level V− of the output signal and the reference level V_{COM}.

Please refer to FIG. 3A. FIG. 3A illustrates a schematic diagram of output waveform of the charge sharing apparatus when the charge sharing apparatus performs charge sharing (compared with FIG. 1B).

As shown in FIG. 3A, the level of the first output signal O1 starts to decrease from the maximum level V+ at a first time t₁, when the level of the first output signal O1 decreases to the second charge sharing level CSL2 (could be any level between the reference level V_{COM} and the minimum level V−), the level of the first output signal O1 will maintain at the second charge sharing level CSL2 for a period of multi-phase charge sharing time Δt₂₁, and then decrease to the minimum level V− and then maintain at the minimum level V− until a second time t₂. Then, the level of the first output signal O1 starts to increase from the minimum level V− at the second time t₂, when the level of the first output signal O1 increases to the first charge sharing level CSL1, the level of the first output signal O1 will maintain at the first charge sharing level CSL1 for a period of multi-phase charge sharing time Δt₂₂, and then increase to a relative high level V_{H} and then maintain at the relative high level V_{H} until a third time t₃ (the end of the cycle).

Similarly, the level of the second output signal O2 starts to increase from the minimum level V− at the first time t₁, when the level of the second output signal O2 increases to the first charge sharing level CSL1 (could be any level between the reference level V_{COM} and the maximum level V+), the level of the second output signal O2 will maintain at the first charge sharing level CSL1 for a period of multi-phase charge sharing time Δt₁₁, and then increase to the maximum level V+ and then maintain at the maximum level V+ until the second time t₂. Then, the level of the second output signal O2 starts to decrease from the maximum level V+ at the second time t₂, when the level of the second output signal O2 decreases to the second charge sharing level CSL2, the level of the second output signal O2 will maintain at the second charge sharing level CSL2 for a period of multi-phase charge sharing time Δt₁₂, and then decrease to a relative low level V_{L} and then maintain at the relative low level V_{L} until the third time t₃ (the end of the cycle).

Compared to FIG. 1B of prior art, the level of the first output signal O1 shown in FIG. 3A has to neither start to decrease from the maximum level V+ to the minimum level V− directly at the first time t₁ nor start to increase from the minimum level V− to the relative high level V_{H} directly at the second time t₂. Similarly, the level of the second output signal O2 shown in FIG. 3A has to neither start to increase from the minimum level V− to the maximum level V+ directly at the first time t₁ nor start to decrease from the maximum level V+ to the relative low level V_{L} directly at the second time t₂.

Please refer to FIG. 3B. FIG. 3B illustrates another schematic diagram of output waveform of the charge sharing apparatus when the charge sharing apparatus performs charge sharing (compared with FIG. 1B).

As shown in FIG. 3B, the level of the first output signal O1 starts to decrease from the maximum level V+ at a first time t₁, when the level of the first output signal O1 decreases to the reference level V_{COM} at a time t₁₁, the level of the first output signal O1 will stop at the reference level V_{COM} at the time t₁₁ and then continuously decreases. When the level of the first output signal O1 decreases to the second charge sharing level CSL2 (could be any level between the reference level V_{COM} and the minimum level V−) at a time t₁₂, the level of the first output signal O1 will stop at the second charge sharing level CSL2 at the time t₁₂ and then continuously decrease to the minimum level V− and then maintain at the minimum level V− until the second time t₂. Then, the level of the first output signal O1 starts to increase from the minimum level V− at the second time t₂, when the level of the first output signal O1 increases to the reference level V_{COM}, the level of the first output signal O1 will stop at the reference level V_{COM} at the time t₂₁ and then continuously increases. When the level of the first output signal O1 increases to the first charge sharing level CSL1 at a time t₂₂, the level of the first output signal O1 will stop at the first charge sharing level CSL1 at the time t₂₂ and then continuously increase to a relative high level V_{H} and then maintain at the relative high level V_{H} until a third time t₃ (the end of the cycle).

Similarly, the level of the second output signal O2 starts to increase from the minimum level V− at the first time t₁, when the level of the second output signal O2 increases to the reference level V_{COM} at the time t₁₁, the level of the second output signal O2 will stop at the reference level V_{COM} at the time t₁₁ and then continuously increases. When the level of the second output signal O2 increases to the first charge sharing level CSL1 (could be any level between the reference level V_{COM} and the maximum level V+) at the time t₁₂, the level of the second output signal O2 will stop at the first charge sharing level CSL1 at the time t₁₂ and then continuously increase to the maximum level V+ and then maintain at the maximum level V+ until the second time t₂. Then, the level of the second output signal O2 starts to decrease from the maximum level V+ at the second time t₂, when the level of the second output signal O2 decreases to the reference level V_{COM}, the level of the second output signal O2 will stop at the reference level V_{COM} at the time t₂₁ and then continuously decreases. When the level of the second output signal O2 decreases to the second charge sharing level CSL2 at the time t₂₂, the level of the second output signal O2 will stop at the second charge sharing level CSL2 at the time t₂₂ and then continuously decrease to a relative low level V_{L} and then maintain at the relative low level V_{L} until the third time t₃ (the end of the cycle).

Compared to FIG. 1B of prior art, the level of the first output signal O1 shown in FIG. 3B has to neither start to decrease from the reference level V_{COM} to the minimum level V− directly at the time t₁₁ nor start to increase from the reference level V_{COM} to the relative high level V_{H} directly at the time t₂₁. Similarly, the level of the second output signal O2 shown in FIG. 3B has to neither start to increase from the reference level V_{COM} to the maximum level V+ directly at the time t₁₁ nor start to decrease from the reference level V_{COM} to the relative low level V_{L} at the time t₂₁.

The difference between FIG. 3A and FIG. 3B is that the charge sharing levels in FIG. 3A are any level CSL1 between the reference level V_{COM} and the maximum level V+ and any level CSL2 between the reference level V_{COM} and the minimum level V−; the charge sharing levels in FIG. 3B are the reference level V_{COM} at first and then change to any level CSL1 between the reference level V_{COM} and the maximum level V+ and any level CSL2 between the reference level V_{COM} and the minimum level V−.

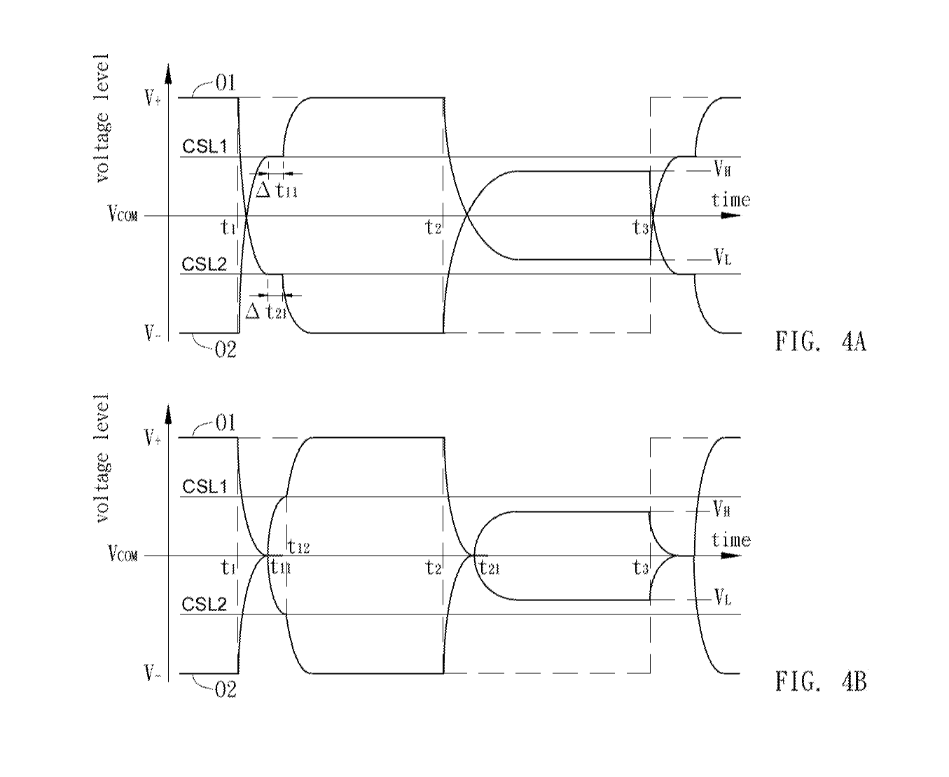

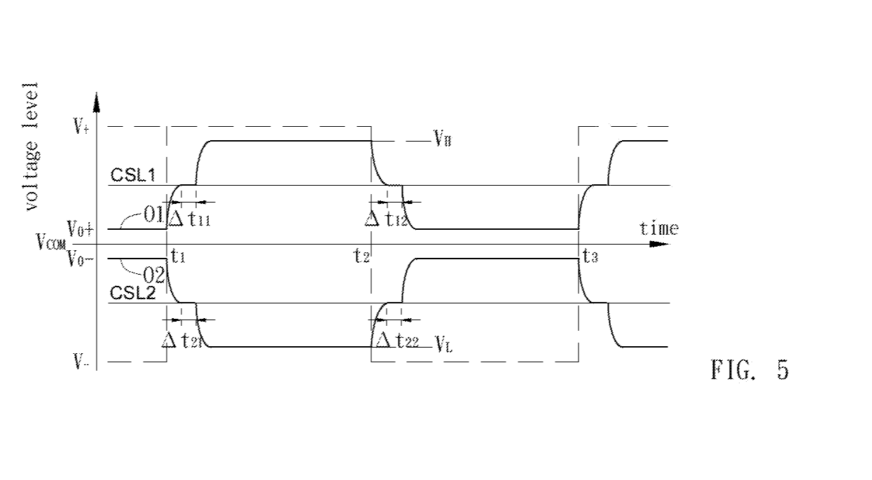

Please refer to FIG. 4A. FIG. 4A illustrates another schematic diagram of output waveform of the charge sharing apparatus when the charge sharing apparatus performs charge sharing (compared with FIG. 1D).

As shown in FIG. 4A, the level of the first output signal O1 starts to decrease from the maximum level V+ at a first time t₁, when the level of the first output signal O1 decreases to the second charge sharing level CSL2 (could be any level between the reference level V_{COM} and the minimum level V−), the level of the first output signal O1 will maintain at the second charge sharing level CSL2 for a period of multi-phase charge sharing time Δt₂₁, and then decrease to the minimum level V− and then maintain at the minimum level V− until a second time t₂. Then, the level of the first output signal O1 starts to increase from the minimum level V− at the second time t₂. It should be noted that the level of the first output signal O1 will increase to a relative high level V_{H} lower than the first charge sharing level CSL1 instead of increasing to the first charge sharing level CSL1, and then the level of the first output signal O1 will maintain at the relative high level V_{H} until the third time t₃ (the end of the cycle).

Similarly, the level of the second output signal O2 starts to increase from the minimum level V− at the first time t₁, when the level of the second output signal O2 increases to the first charge sharing level CSL1 (could be any level between the reference level V_{COM} and the maximum level V+), the level of the second output signal O2 will maintain at the first charge sharing level CSL1 for a period of multi-phase charge sharing time Δt₁₁, and then increase to the maximum level V+ and then maintain at the maximum level V+ until the second time t₂. It should be noted that the level of the second output signal O2 will decrease to a relative low level V_{L} higher than the second charge sharing level CSL2 instead of decreasing to the second charge sharing level CSL2, and then the level of the second output signal O2 will maintain at the relative low level V_{L} until the third time t₃ (the end of the cycle).

Compared to FIG. 1D of prior art, the level of the first output signal O1 shown in FIG. 4A has not to start to decrease from the maximum level V+ to the minimum level V− directly at the first time t₁. Similarly, the level of the second output signal O2 shown in FIG. 4A has not to start to increase from the minimum level V− to the maximum level V+ directly at the first time t₁.

Please refer to FIG. 4B. FIG. 4B illustrates another schematic diagram of output waveform of the charge sharing apparatus when the charge sharing apparatus performs charge sharing (compared with FIG. 1D).

As shown in FIG. 4B, the level of the first output signal O1 starts to decrease from the maximum level V+ at a first time t₁, when the level of the first output signal O1 decreases to the reference level V_{COM} at a time t₁₁, the level of the first output signal O1 will stop at the reference level V_{COM} at the time t₁₁ and then continuously decreases. When the level of the first output signal O1 decreases to the second charge sharing level CSL2 (could be any level between the reference level V_{COM} and the minimum level V−) at a time t₁₂, the level of the first output signal O1 will stop at the second charge sharing level CSL2 at the time t₁₂ and then continuously decrease to the minimum level V− and then maintain at the minimum level V− until the second time t₂. Then, the level of the first output signal O1 starts to increase from the minimum level V− at the second time t₂, when the level of the first output signal O1 increases to the reference level V_{COM}, the level of the first output signal O1 will stop at the reference level V_{COM} at the time t₂₁ and then continuously increases. It should be noted that the level of the first output signal O1 will increase to a relative high level V_{H} lower than the first charge sharing level CSL1 instead of increasing to the first charge sharing level CSL1, and then the level of the first output signal O1 will maintain at the relative high level V_{H} until the third time t₃ (the end of the cycle).

Similarly, the level of the second output signal O2 starts to increase from the minimum level V− at the first time t₁, when the level of the second output signal O2 increases to the reference level V_{COM} at the time t₁₁, the level of the second output signal O2 will stop at the reference level V_{COM} at the time t₁₁ and then continuously increases. When the level of the second output signal O2 increases to the first charge sharing level CSL1 (could be any level between the reference level V_{COM} and the maximum level V+) at the time t₁₂, the level of the second output signal O2 will stop at the first charge sharing level CSL1 at the time t₁₂ and then continuously increase to the maximum level V+ and then maintain at the maximum level V+ until the second time t₂. Then, the level of the second output signal O2 starts to decrease from the maximum level V+ at the second time t₂, when the level of the second output signal O2 decreases to the reference level V_{COM}, the level of the second output signal O2 will stop at the reference level V_{COM} at the time t₂₁ and then continuously decreases. It should be noted that the level of the second output signal O2 will decrease to the relative low level V_{L} higher than the second charge sharing level CSL2 instead of decreasing to the second charge sharing level CSL2, and then the level of the second output signal O2 will maintain at the relative low level V_{L} until the third time t₃ (the end of the cycle).

Compared to FIG. 1D of prior art, the level of the first output signal O1 shown in FIG. 4B has not to start to decrease from the reference level V_{COM} to the minimum level V− directly at the time t₁₁. Similarly, the level of the second output signal O2 shown in FIG. 4B has not to start to increase from the reference level V_{COM} to the maximum level V+ directly at the time t₁₁.

The difference between FIG. 4A and FIG. 4B is that the charge sharing levels in FIG. 4A are any level CSL1 between the reference level V_{COM} and the maximum level V+ and any level CSL2 between the reference level V_{COM} and the minimum level V−; the charge sharing levels in FIG. 4B are the reference level V_{COM} at first and then change to any level CSL1 between the reference level V_{COM} and the maximum level V+ and any level CSL2 between the reference level V_{COM} and the minimum level V−.

FIG. 5 illustrates a schematic diagram of another output waveform of the charge sharing apparatus when the charge sharing apparatus performs charge sharing (compared with FIG. 1E).

It should be noted that the TFT-LCD will perform charge sharing only when the relative high level V_{H} is higher than the first charge sharing level CSL1 or the relative low level V_{L} is lower than the second charge sharing level CSL2. In fact, the first charge sharing level CSL1 can be a central level between the reference level V_{COM} and the maximum level V+; the second charge sharing level CSL2 can be a central level between the reference level V_{COM} and the minimum level V−, but not limited to this.

As shown in FIG. 5, the level of the first output signal O1 starts to increase from a first initial level V₀+ at the first time t₁, when the level of the first output signal O1 increases to the first charge sharing level CSL1, the level of the first output signal O1 will maintain at the first charge sharing level CSL1 for a period of multi-phase charge sharing time Δt₁₁, and then increase to the relative high level V_{H} and then maintain at the relative high level V_{H} until the second time t₂. Then, the level of the first output signal O1 starts to decrease from the relative high level V_{H} at the second time t₂, when the level of the first output signal O1 decreases to the first charge sharing level CSL1, the level of the first output signal O1 will maintain at the first charge sharing level CSL1 for a period of multi-phase charge sharing time Δt₁₂, and then decrease to the first initial level V₀+ and then maintain at the first initial level V₀+ until the third time t₃ (the end of the cycle).

Similarly, the level of the second output signal O2 starts to decrease from a second initial level V₀− at the first time t₁, when the level of the second output signal O2 decreases to the second charge sharing level CSL2, the level of the second output signal O2 will maintain at the second charge sharing level CSL2 for a period of multi-phase charge sharing time Δt₂₁, and then decrease to the relative low level V_{L} and then maintain at the relative low level V_{L} until the second time t₂. Then, the level of the second output signal O2 starts to increase from the relative low level V_{L} at the second time t₂, when the level of the second output signal O2 increases to the second charge sharing level CSL2, the level of the second output signal O2 will maintain at the second charge sharing level CSL2 for a period of multi-phase charge sharing time Δt₂₂, and then increase to the second initial level V₀− and then maintain at the second initial level V₀− until the third time t₃ (the end of the cycle).

Compared to FIG. 1E of prior art, the first output signal O1 and the second output signal O2 will perform charge sharing only when the relative high level V_{H} is higher than the first charge sharing level CSL1 or the relative low level V_{L} is lower than the second charge sharing level CSL2. The level of the first output signal O1 shown in FIG. 5 has to neither start to increase from the first initial level V₀+ to the relative high level V_{H} directly at the time t₁₁ nor start to decrease from the relative high level V_{H} to the first initial level V₀+ directly at the time t₂. Similarly, the level of the second output signal O2 shown in FIG. 5 has to neither start to decrease from the second initial level V₀− to the relative low level V_{L} directly at the time t₁ nor start to increase from the relative low level V_{L} to the second initial level V₀− at the time t₂.

Above all, the charge sharing apparatus of the invention determines whether to perform charge sharing according to the target level and includes following types of:

(1) performing no charge sharing;

(2) performing charge sharing to make that the charge sharing level is the reference level V_{COM};

(3) performing charge sharing to make that the charge sharing levels are any level CSL1 between the maximum level V+ and the reference level V_{COM} and the any level CSL2 between the minimum level V− and the reference level V_{COM}.

(4) performing charge sharing to make that the charge sharing level is the reference level V_{COM} at first and then changes to any level CSL1 between the maximum level V+ and the reference level V_{COM} and the any level CSL2 between the minimum level V− and the reference level V_{COM}.

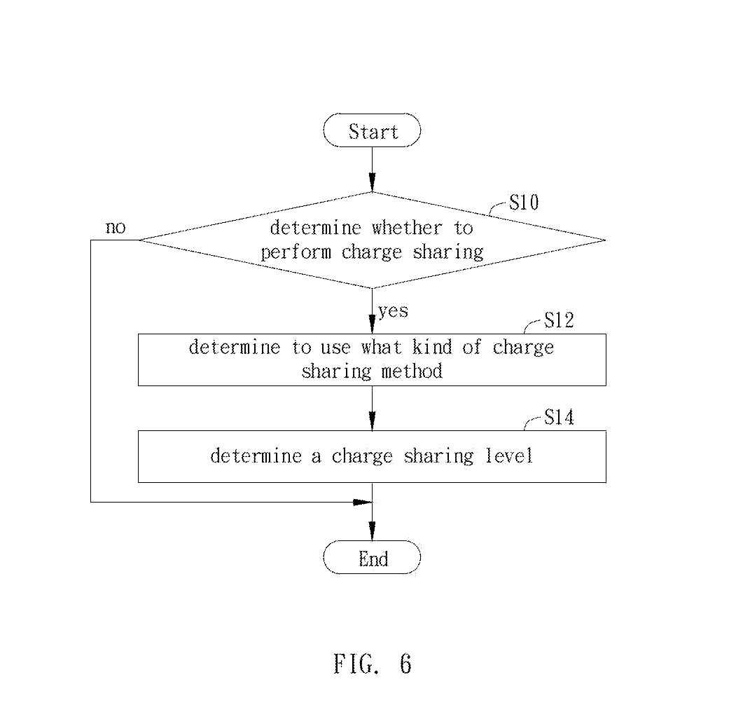

Another embodiment of the invention is a charge sharing method. In this embodiment, the charge sharing method is applied in a driving circuit of a liquid crystal display, and the driving circuit includes at least one data latch and at least one output switch, but not limited to this. Please refer to FIG. 6. FIG. 6 illustrates a flow chart of the charge sharing method in this embodiment.

As shown in FIG. 6, in the step S10, the method will determine whether to perform charge sharing. If the determined result of the step S10 is yes, the method will perform the step S12 to determine to use what kind of charge sharing method.

In this embodiment, the charge sharing methods includes:

(1) performing charge sharing to make that the charge sharing level is the reference level V_{COM};

(2) performing charge sharing to make that the charge sharing levels are any level CSL1 between the maximum level V+ and the reference level V_{COM} and the any level CSL2 between the minimum level V− and the reference level V_{COM}.

(3) performing charge sharing to make that the charge sharing level is the reference level V_{COM} at first and then changes to any level CSL1 between the maximum level V+ and the reference level V_{COM} and the any level CSL2 between the minimum level V− and the reference level V_{COM}.

Then, in the step S14, the method determines a charge sharing level. In practical applications, the charge sharing level is between a maximum level of the at least one output signal and a reference level of the driving circuit and/or between the reference level and a minimum level of the at least one output signal.

Wherein, the reference level is between the maximum level and the minimum level. When a level variation curve versus time of the output signal is increased or decreased to the charge sharing level, the level variation curve versus time of the output signal will maintain at the charge sharing level.

In practical applications, the method can selectively adjust a level changing state of at least one output signal outputted by the at least one output switch according to the at least one charge sharing level. The at least one data signal inputted to the at least one data latch is processed by the driving circuit to become the at least one output signal outputted by the at least one output switch. The step S14 can determine the data type of the at least one data signal inputted to the at least one data latch at first, and then generate the at least one charge sharing level accordingly.

Compared to the prior art, the charge sharing apparatus and charge sharing method of the invention provide at least one charge sharing level different from the reference level between the maximum level and minimum level of the data signal to adjust the level changing state of the output signal. Therefore, when the positive polarity and negative polarity of the data signal are exchanged, the source driver has not to provide more charges to effectively reduce total power consumption and enhance driving efficiency.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A charge sharing apparatus, applied in a driving circuit of a liquid crystal display, the driving circuit comprising at least one data latch and at least one output switch, the charge sharing apparatus comprising:
a generating module, coupled to the at least one data latch, for generating at least one charge sharing level according to at least one data signal inputted to the at least one data latch; and
an adjusting module, coupled between the generating module and the at least one output switch, for selectively adjusting a level changing state of at least one output signal outputted by the at least one output switch according to the at least one charge sharing level.

2. The charge sharing apparatus of claim 1, wherein the generating module comprises a data determining unit, the data determining unit is used to determine data type of the at least one data signal inputted to the at least one data latch and generate the at least one charge sharing level accordingly.

3. The charge sharing apparatus of claim 1, wherein the at least one charge sharing level is between a maximum level and a minimum level of the at least one output signal, but different from a reference level of the driving circuit.

4. The charge sharing apparatus of claim 1, wherein the at least one charge sharing level is between a maximum level of the at least one output signal and a reference level of the driving circuit and/or between the reference level and a minimum level of the at least one output signal, the reference level is between the maximum level and the minimum level.

5. The charge sharing apparatus of claim 1, wherein when a level variation curve versus time of the output signal is increased or decreased to the charge sharing level, the level variation curve versus time of the output signal maintains at the charge sharing level.

6. The charge sharing apparatus of claim 1, wherein the at least one data latch comprises a first data latch unit and a second data latch unit used to receive a first data signal and a second data signal of the at least one data signal respectively, the at least one output switch comprises a first output switch and a second output switch used to output a first output signal and a second output signal of the at least one output signal respectively.

7. The charge sharing apparatus of claim 6, wherein the driving circuit further comprises a first level shifter, a first digital-to-analog converter, a first amplifier, a second level shifter, a second digital-to-analog converter, and a second amplifier; the first data signal received by the first data latch unit is processed by the first level shifter, the first digital-to-analog converter, the first amplifier in order to become the first output signal and the first output signal is outputted by the first output switch; the second data signal received by the second data latch unit is processed by the second level shifter, the second digital-to-analog converter, the second amplifier in order to become the second output signal and the second output signal is outputted by the second output switch.

8. A charge sharing method, applied in a driving circuit of a liquid crystal display, the driving circuit comprising at least one data latch and at least one output switch, the method comprising steps of:
(a) generating at least one charge sharing level according to at least one data signal inputted to the at least one data latch; and
(b) selectively adjusting a level changing state of at least one output signal outputted by the at least one output switch according to the at least one charge sharing level.

9. The charge sharing method of claim 8, wherein the step (a) is to determine data type of the at least one data signal inputted to the at least one data latch and generate the at least one charge sharing level accordingly.

10. The charge sharing method of claim 8, wherein the at least one charge sharing level is between a maximum level and a minimum level of the at least one output signal, but different from a reference level of the driving circuit.

11. The charge sharing method of claim 8, wherein the at least one charge sharing level is between a maximum level of the at least one output signal and a reference level of the driving circuit and/or between the reference level and a minimum level of the at least one output signal, the reference level is between the maximum level and the minimum level.

12. The charge sharing method of claim 8, wherein when a level variation curve versus time of the output signal is increased or decreased to the charge sharing level, the level variation curve versus time of the output signal maintains at the charge sharing level.

13. The charge sharing method of claim 8, wherein the at least one data signal inputted to the at least one data latch is processed by the driving circuit to become the at least one output signal outputted by the at least one output switch.
